(19) United States
(12) Patent Application Publication
(10) Pub. No.: US 2008/0071849 A1
(43) Pub. Date: Mar. 20, 2008

(54) Polynomial method for detecting a Hamiltonian circuit

(76) Inventor: Cynthia Ann Harlan Krieger, Lowell, MA (US)

Correspondence Address: MCKENNA LONG & ALDRIDGE LLP, 1900 K STREET, NW, WASHINGTON, DC, 20006, US

(21) Appl. No.: 11/898,928

(22) Filed: Sep. 17, 2007

Related U.S. Application Data
(60) Provisional application No. 60/844,680, filed on Sep. 15, 2006.

(51) Int. Cl. G06F 7/32

(52) U.S. Cl. 708/520

(57) ABSTRACT

An NP-complete problem can be transformed in polynomial time into any known NP problem. The Hamiltonian circuit problem may be transformed into any other known NP problem (such as the Traveling Salesman problem) and has applications in any context that can be represented by a graph, map, or network structure. The reverse calculation of this transformation from any NP problem into the NP-complete Hamiltonian circuit problem also has a polynomial running time. The composition of this reverse calculation from any known NP problem to the Hamiltonian circuit problem with the polynomial running time of the given algorithm together form a polynomial running time algorithm. Therefore, with this polynomial running time calculation result given for detecting the presence of a Hamiltonian circuit in an undirected graph, it has been shown that P equals any known NP problem or NP. Hence the existence of this Hamiltonian circuit detection algorithm proves P=NP.

This application claims the benefit of U.S. Provisional Patent Application No. 60/844,680, filed on Sep. 15, 2006, which is hereby incorporated by reference for all purposes as if fully set forth herein.

### BACKGROUND OF THE INVENTION

1. Field of the Invention

The present invention relates to computer software and execution of software algorithms.

2. Discussion of the Related Art

Computers have become increasingly useful for modeling, simulating and solving very complex problems. In part this has been due to the rapid development of integrated circuit and processor technology, but to a great extent the successful use of computers in understanding highly complex problems is due to the ability of computer scientists to reduce complex phenomena to mathematical models and then to craft algorithms that can efficiently and effectively solve or compute the mathematical model.

When creating or modeling phenomena for application on a computer, the computer's structure and operation must be taken into account, because that determines the kinds of algorithms or programs that can be written to run on it, and also determines how those programs are run. For example, ordinary microprocessor based computers such as desktop computers, having central processing units for executing instructions, memory units for storing data, and output devices for rendering output, are known as ‘deterministic sequential computers’ because given the computer's present state and any inputs, there is only one possible action that the computer might take, and it performs actions one after the other, sequentially. From a theoretical standpoint, these computers are also called “deterministic Turing machines”. In fact, these characteristics are shared by all practical computers, including machines capable of vector processing and parallel processing.

More generally, there are some mathematical problems, such that when a computer is programmed to solve them, the computer's run time is no greater than a polynomial function of the problem's size, or the number of its inputs. For example, a common computer algorithm known as a quicksort is a sorting algorithm for sorting n integers. It is known that the computer must perform An² operations to sort all n integers, where A is a constant. Thus regardless of the number of integers to be sorted, the run time increases by a polynomial amount. When run-time is a polynomial function of the number of inputs, the problem is said to be solvable in polynomial time. Theoretically speaking, the class of problems that can be solved on a deterministic sequential machine in polynomial time is known as ‘P’.

But as the phenomena and problems to be solved on computers become more complex, it is increasingly more difficult to construct algorithms capable of solving the mathematical problems. This is because for many mathematical problems, no algorithm has yet been devised that can solve the problem in polynomial time. An illustration of this phenomena can be found in the ‘subset-sum’ problem, which has applications in cryptography. The problem asks: given a set of integers, does the sum of some non-empty subset equal 0? For example, given the set {−7, −3, −2, 5, 8}, is there a subset of these integers that sum to 0? The simplest way to solve such a problem is to test all the possible combinations, also called a brute force approach, and doing so very quickly reveals such a subset, {−3, −2, 5}, which sums to zero. But this problem is deceptively complex, for as the number of integers n in the original set grows, it is clear that a brute force algorithm will have to check 2ⁿ*n combinations. Thus the algorithm's run-time grows exponentially in relation to the number of inputs, not polynomially. Problems of this type, or complexity, are referred to as NP problems, because while it is not known whether they are solvable in polynomial time, and all known algorithms for solving them run in greater than polynomial time, such as exponential time, for example.

NP problems arise in a number of contexts, including graph theory, network design, sets and partitions, storage and retrieval, sequencing and scheduling, mathematical programming, algebra and number theory, games and puzzles, logic, automata and languages, and program optimization, among others. Among these NP problems is a particularly difficult subclass of problems known as NP-complete problems, which have the characteristic that every other NP problem can be reduced or transformed into an NP-complete problem. In other words, because an entire class of NP problems can be reduced to any NP-complete problem, it means they are all, in a sense, the same fundamental problem. Furthermore, if a polynomial running-time algorithm is devised for one NP-complete problem, then it would mean that a polynomial running time algorithm exists for all NP problems. This in turn would mean that the class of problems P and the class of problems NP are in fact the same class (P=NP)

Literature in the field of algorithms has addressed the long-standing P=NP question extensively. For example, the text Computers and Intractability. A Guide to the Theory of NP-Completeness, by Michael R. Garey and David S. Johnson (2003 edition), which is hereby incorporated by reference for all purposes as if fully incorporated herein, discusses over 300 known NP-complete problems in a variety of categories. Among those discussed is the Hamiltonian circuit problem.

A practical and illustrative example of the Hamiltonian circuit problem is as follows. Given a set of cities and roads between them, is there a way to begin at one city, travel to all other cities only once, and return to the starting city? Speaking more generally, given a graph having a number of vertices and edges between vertices, a Hamiltonian circuit is a path that begins at one node, travels along the edges to visit every other node exactly once, and returns to the starting node.

More specifically, a Hamiltonian circuit consists of a pathway having two requirements. The first requirement is that the pathway must include every vertex within the graph exactly once, with the exception of the starting and stopping location of the pathway, must the same vertex. The second requirement is that the pathway must not utilize any edge more than once along its route from start to finish. This problem clearly has applications in logistics as seen from the city example discussed above, but it also has applicability to data processing as well. In fact, the Hamiltonian circuit problem applies to any problem that can be abstracted to a graph with vertices and edges between them.

While brute force methods for detecting the presence of a Hamiltonian circuit in a graph exist, they are not useful for anything but the most rudimentary applications, because the running time of these algorithms grows exponentially in relation to the number of vertices in the graph. An algorithm for detecting a Hamiltonian circuit that runs in polynomial time is needed. More importantly, however, the determination of a polynomial running time software algorithm for determining the presence of a Hamiltonian circuit in a given graph would have significant implications for all aspects of computer software, as it would mean that algorithms which previously had unknown or unpredictable running times or for which the only known algorithms had exponential-running times, would in fact be transformable in to algorithms having polynomial running times.

### SUMMARY OF THE INVENTION

Accordingly, the present invention is directed to systems and methods for detecting a Hamiltonian Circuit that substantially obviates one or more of the problems due to limitations and disadvantages of the related art.

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system and method for determining whether a given undirected graph composed of vertices and edges contains a Hamiltonian circuit includes an adjacency matrix representation of an undirected graph, X=(V,E), where |V| is the number of vertices within the graph and |E| is the number of edges in the graph; verifying that the adjacency matrix X is square; verifying that each element of the adjacency matrix X is either one or zero; copying adjacency matrix X to A, and making each element in A equal to zero; setting the column rank variable of each of adjacency matrices X and A to r_{X} and r_{A}, respectively, which are equal to the number of vertices n in the undirected graph |V|; determining whether there are at least two separate one elements within a row or a column; creating a simple connected clock face type graph containing a Hamiltonian circuit in the adjacency matrix A; forming a projection matrix P=(A^{t})*A multiplying the projection matrix P and the adjacency matrix X, (PX=P·X); and determining whether PX is self consistent by comparing the modified column ranks of the two matrices and by comparing the repetition of the QR auxiliary values of the X matrix.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B illustrate an algorithm according to an embodiment of the present invention.

FIG. 2 illustrates an algorithm according to an embodiment of the present invention within a graph.

### DETAILED DESCRIPTION OF THE ILLUSTRATED EMBODIMENTS

Reference will now be made in detail to an embodiment of the present invention, an example of which is illustrated in the accompanying drawings.

It is known that an NP-complete problem can be transformed into any known NP problem, and that this transformation can be done in polynomial time. Thus, in the example above the Hamiltonian circuit problem may be transformed into any other known NP problem (such as the Traveling Salesman problem) and has applications in any context that can be represented by a graph, map, or network structure as well as a multitude of other applications listed in the Computers and Intractability text. The reverse calculation of this transformation, i.e. from any NP problem back into the NP-complete Hamiltonian circuit problem also has a polynomial running time. The composition of this reverse calculation from any known NP problem to the Hamiltonian circuit problem with the polynomial running time of the given algorithm together form a polynomial running time algorithm. In other words, any problem belonging to the class of problems known as NP would be transformable into problems belonging in the class of P. Hence a Hamiltonian circuit detection algorithm which runs in polynomial time proves P=NP.

One way to process graphs using computer algorithms is to represent the graph as a matrix. This is a convenient approach to processing graphs because it takes advantage of mathematics software or programming languages that have pre-built function libraries for handling matrix algebra. One type of matrix suitable for handling an undirected graph, such as a graph that may include a Hamiltonian circuit, is an adjacency matrix. This adjacency matrix is a square matrix with a number of rows and columns equal to the total number of vertices. The integer values stored at each column and row position, i.e. each element, in the matrix correspond to the number of edges between the vertices corresponding to those columns and rows. In addition to representing a graph as matrix, a Hamiltonian detection algorithm can take advantage of the fact that any Hamiltonian circuit of a given size may be permuted or rearranged into another Hamiltonian circuit of the same size.

In this example, the polynomial-time Hamiltonian circuit detection algorithm begins with accepting input in the form of an adjacency matrix representation of the undirected graph, X=(V,E) under consideration, where |V| is the number of vertices within the graph and |E| is the number of edges in the graph. The adjacency matrix is therefore input as a |V|×|V| sized matrix.

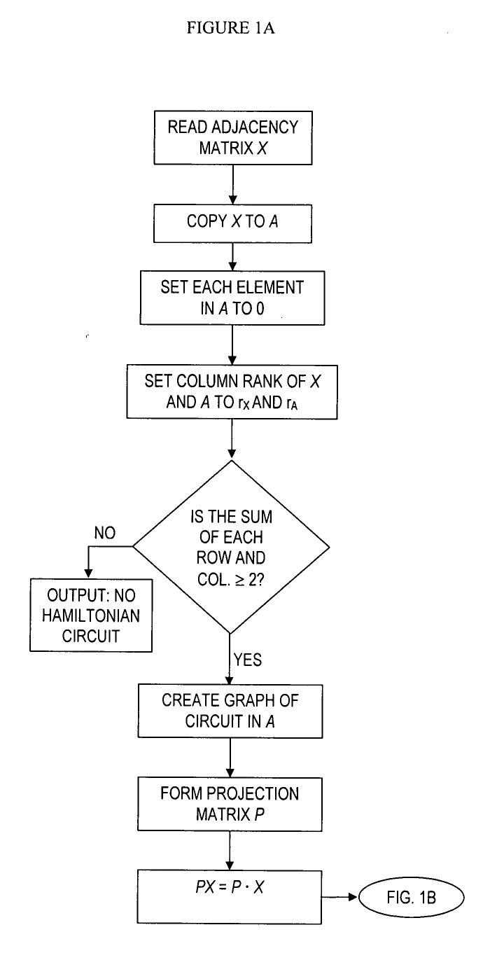

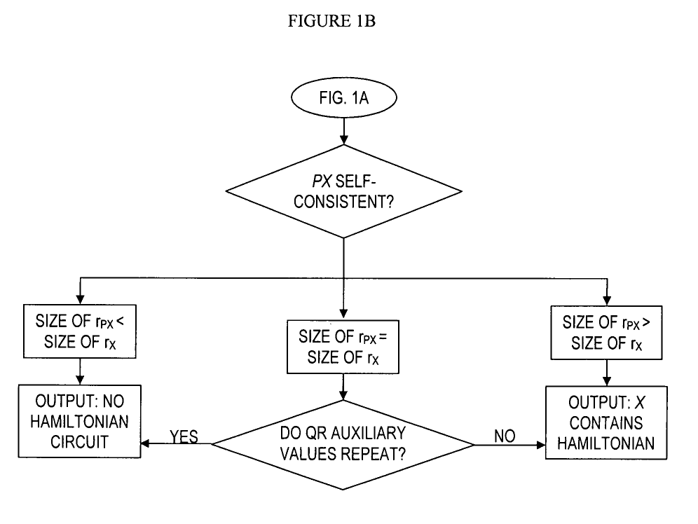

The steps within the algorithm are as follows, and are illustrated in FIGS. 1A and 1B.

The first step involves obtaining the start time of the algorithm and printing this time to an output file. This step is optional; however, it will later facilitate confirmation of the polynomial running time.

In this exemplary embodiment of the invention, the algorithm verifies that the adjacency matrix is square. If the matrix reflects an undirected graph, then any two vertices can have at most one edge between them. Accordingly, an adjacency matrix holding an undirected graph should only contain 1's and 0's. The adjacency matrix will hold a 1 at a row and column position that corresponds to the one edge between the vertex corresponding to that row and the vertex corresponding to that column. The adjacency matrix will hold a zero where no edges are between the corresponding vertices. Therefore, at step 102, the algorithm may read in the adjacency matrix of the undirected graph X from an input source such as an input file. The algorithm may then verify that the matrix is square, that is, that the number of rows equals the number of columns and that this number equals the number of vertices within the undirected graph. The algorithm may then check that each element of this adjacency matrix contains only inputs of either one or zero.

Because the algorithm knows the number of rows and columns of the input matrix (i.e., the size of the input matrix), another matrix of the same size may be created that stores a simple Hamiltonian circuit and against which the input can be compared. One example of a simple Hamiltonian circuit is a clock-face graph, in which the vertices are arranged in a circle like the numbers on a clock face, with one edge between them. Other simple Hamiltonian circuits could be used. The simple Hamiltonian circuit may be previously stored or it may be generated as needed. A simple way to create a matrix of the same size as the input matrix is to copy the input matrix. Thus, in the next step of the algorithm, step 103, the algorithm copies the adjacency matrix of the undirected graph X to an adjacency matrix A. Matrix A will ultimately hold the graph with the known Hamiltonian circuit against which the input matrix X will be compared.

Next, at step 104, the algorithm sets each element in the new adjacency matrix A equal to zero. After this step, a graph that has the same number of vertices as the graph in X may be created in A. One way to do this is to determine the rank of the matrix X, which is a measurement of the size of the matrix, and set the rank of the matrix A to that same rank. Thus, in accordance with step 105, the algorithm sets the column rank variable for the adjacency matrix X as well as matrix A to r_{X} and r_{A}, respectively, which are equal to the number of vertices |V| in the undirected graph. For clarity of notation, we will use the variable n to refer to the number of vertices in the undirected graph.

Once the sizes of the respective matrices are determined and set, the algorithm may then verify whether the graph in X is a connected graph, meaning that every vertex has at least one edge leading into it and one edge leading away from it. More simply, a connected graph is a graph for which each vertex is connected to at least two other vertices. If the graph is not connected, then that graph cannot include a Hamiltonian circuit, because it would be impossible to traverse all vertices. However, the fact that a graph is connected does not necessarily mean that that graph contains a Hamiltonian circuit. Having a connected graph is a necessary but not sufficient condition for being a Hamiltonian. In a matrix representation, in each row and each column, there must be at least two separate ‘1’ values, each of those 1's representing a separate edge.

Next, the algorithm at step 106 determines whether or not there are two separate ‘1’ elements within a given row or a column by adding up the elements of each row and column in matrix X. The algorithm can then verify that the sum of the elements in each row and the sum of the elements in each column is at least 2. If the sum is less than two, then it means there is a vertex that is only connected to one other vertex. However, the fact that the sum is greater than or equal to two for every row and column does not mean that the graph in X contains a Hamiltonian circuit, only that it could contain one. Thus, if every row and column sum equals at least a two, the algorithm can proceed. If the sum of each row and column does not equal at least 2, then the algorithm halts and there is no Hamiltonian circuit in X

If the algorithm determines that the input matrix contains a connected graph, matrix A created in steps 103 and 104 above may be filled with values that represent a known, simple Hamiltonian circuit that is the same size as the matrix X. Thus, at step 107, matrix A is populated with a clock-face Hamiltonian graph. An exemplary way of doing this is to set, for matrix A, all of the elements in the diagonal immediately below the main diagonal equal to ‘1’, and set the elements of the diagonal immediately above the main diagonal equal to ‘1’. Each diagonal, the one above and one below the main diagonal of matrix A, is a respective direction around the clock face. Because a Hamiltonian circuit relates to an undirected graph, both diagonals are populated with 1's. This creates the connected clock face having an edge from vertex 1 at the top of the clock to vertex 2, from vertex 2 to vertex 3, from vertex 3 to vertex 4, and so forth, until an edge from vertex n back to vertex 1 is created. The placement of this last edge is accomplished by setting the elements A[1,n]=1 and by setting the elements A[n,1]=1. All the other elements with in the adjacency matrix A remain set to ‘0’. It is understood that this step may be done immediately after steps 103 and 104.

Because adjacency matrices representing undirected graphs are symmetric and square, and because matrices representing a Hamiltonian circuit may be arranged otherwise, though capable of being reduced to a symmetric, square arrangement, the next steps in the algorithm are to transform the graphs in A and X to common spaces. In matrix algebra, this is done by forming the projection matrix P=A^{t}·A, or by squaring the newly constructed adjacency matrix to form, the projection matrix P, in accordance with step 108. When using directed graphs, the equation would be modified to P=A^{t}·A, where A^{t} is the transpose of the adjacency matrix A. Step 108 creates a projection of the known Hamiltonian circuit in matrix A in one space where it can be used to compare against a projection of the input graph in X.

After the projection matrix P is formed, the algorithm reduces the graph in X to the P space, This is to transform the graph in X into the same space that the known Hamiltonian circuit in A was transformed to. Thus, at step 109, the newly created projection matrix P is applied to the undirected graph under consideration X by multiplying both matrices together, with P being applied on the left side of X, or the new product being represented by PX=P·X. This is done so that the graph in X is compared to a known Hamiltonian circuit in the same vector space as X.

After these operations, it may be useful to determine whether the newly form matrix PX contains any internal or inherent contradictions. An example of a contradiction would be a row and column pair a,b that contains a ‘1’, indicating that an edge connects the two vertices, but row and column pair b,a contains a ‘0’ indicating no connection. This is contradictory. If PX contains inherent or internal contradictions, then it means that information about the graph in X has been lost in the transformation to PX. In other words, it means that the vector space of PX is not large enough to hold X. In the context of the current example, in which P holds a simple Hamiltonian circuit of the same size as the graph in X, this means that X is larger than P, or that there are vertices in X which are not reachable on a Hamiltonian circuit. Therefore, if PX contains any internal contradictions, then the graph in X is not a Hamiltonian circuit.

Mathematically speaking, this is referred to as testing for self-consistency. In the context of the present example, the algorithm tests if PX is self-consistent at step 109. After the matrix X is multiplied by the projection matrix P, the rank of PX and the rank of X can be modified to eliminate extraneous values and preserve the information-rich component of the vector space. In matrix algebra, such a process is often referred to as a ‘decomposition’, and a variety of decompositions are available that can be applied to a matrix to extract the information content from the matrix. One such decomposition is known as a QR decomposition. The QR decomposition is a way of factoring a matrix to separate out the information-rich component of the vector space. Performing a QR decomposition on the matrix X and matrix PX generates values known as QR auxiliary values.

At step 110, the algorithm determines whether or not the newly constructed matrix PX is self-consistent. The mathematics of the self-consistency determination are discussed in greater detail below. If PX is self-consistent, it means information has been lost going from X to PX. The algorithm may determine the self-consistency by calculating a modified column rank r_{PX} and r_{X} for each of the two adjacency matrices PX and X, respectively. The algorithm modifies the column rank by decrementing by one for each QR auxiliary value repeated in the matrix and by decrementing by one for each QR auxiliary value equal to zero. With an appropriate change of basis, or a realignment of coordinates, one can move among vector spaces of the same column rank size, this can be done by comparing the size of r_{PX} and r_{X}. When comparing the sizes of r_{PX} and r_{X}, there are three possible cases.

The first case, at step 110a, is where the size of r_{PX} is smaller than the size of r_{X}. If the rank of PX is smaller than the rank of X, then the matrix PX is not large enough to hold all of the matrix X. However, because P contains a known Hamiltonian circuit, then there is more information in X that was not captured by the Hamiltonian cycle in P, therefore there is no Hamiltonian circuit in X. More particularly, because the matrix multiplication performed reduced the size of the column rank, applying the Hamiltonian circuit projection matrix P to the original data matrix X resulted in a reduction. Hence X is bigger than a Hamiltonian circuit, which implies there are vertices that are not reachable, which is contrary to one of the definitions of a Hamiltonian circuit. Since the Hamiltonian circuit in P utilized the same number of vertices as the graph represented in the original data matrix X, data matrix X contains an independent vector structure or space while the matrix PX contains a dependent vector structure or space. This means that the vector space spanned by X is bigger than the vector space spanned by PX. But because PX contained the Hamiltonian circuit composed of n vertices, X cannot contain a Hamiltonian cycle, and the algorithm can terminate by printing or outputting that X does not contain a Hamiltonian circuit.

In the second case, at step 110b, r_{PX} is equal to r_{X}. Now consider two sub-cases.

The first sub-case, considers the possibility that while all vertices in matrix X are reachable, it may be that some edges need to be traversed twice, which violates the conditions of the Hamiltonian circuit. One way to check for this is to see if the QR auxiliary values repeat. If a QR auxiliary value repeats, this indicates that a vertex has already been traveled, and the number of times the QR auxiliary value repeats is the number of times through which that vertex is traveled on the projected Hamiltonian circuit. Because a Hamiltonian circuit can only travel through each vertex once and not repeat any vertex, (with the exception of the last vertex), then there does not exist a Hamiltonian circuit within the graph represented by the adjacency matrix X. The algorithm can terminate here, and it can output that the graph represented by the matrix X is not a Hamiltonian circuit.

In the second sub-case, none of the QR auxiliary values of the original data matrix X repeat. This means that each vertex within X was traveled only once. So, if the two column ranks are equal and one of them contains a Hamiltonian circuit then merely by a matrix transformation it can become a Hamiltonian circuit, and therefore the original undirected graph represented by matrix X contains a Hamiltonian circuit. The algorithm can terminate here with the result that the graph represented by X is a Hamiltonian circuit. At this point, the algorithm may output that the graph represented by the matrix X is a Hamiltonian circuit.

Returning to the comparison of the ranks, at step 110c, if the rank of PX is greater than X, that means that PX contains all the information about X. In other words, if the size of r_{PX} is larger than that of r_{X}, then because the multiplication of two matrices resulted in a larger column rank of a vector space spanned by PX, the vector space spanned by PX is a globally sufficient estimator for the original matrix X. In other words, it means that when P was applied to matrix X, no information from X was lost. PX therefore contains a Hamiltonian circuit. Further, the graph represented by the matrix X must contain a Hamiltonian circuit, so the algorithm may output that the graph represented by the matrix X is a Hamiltonian circuit.

Prior to any of the aforementioned termination steps, whether or not a Hamiltonian circuit is detected, the algorithm may output the stop time. This step, like the step of outputting the start time is optional. Together, the start time and the stop time may be used by to derive the running time. The running time may be compared to the number of inputs to verify that the algorithm runs in polynomial time relative to the number of inputs.

Thus, the example presented above offers a way to determine whether a given graph is a Hamiltonian circuit.

The determination of self-consistency discussed briefly above in step 110, is arguably a complex aspect of the algorithm. It will therefore be discussed in detail herein below.

One way to determine whether or not a projection matrix is self-consistent is to find the column rank of both the original and projected matrices under consideration and compare them. The column rank is a direct indication of the vector space spanned by each matrix. In order to get an accurate column rank, the algorithm may generate a spectral decomposition representation of each of the aforementioned matrices. The algorithm may accomplish this by performing a QR decomposition on the matrix.

More specifically, the algorithm may accomplish the QR decomposition by executing a QR decomposition algorithm with pivoting. Such algorithms are well known in the art. The QR decomposition algorithm computes the spectral decomposition of each adjacency matrix under consideration, PX and X. The QR decomposition without pivoting expresses a n×n matrix as the product of an n by n orthogonal matrix Q and an n by n upper triangular matrix R. The matrix Q is represented as a product of elementary reflectors. An elementary reflector, also referred to as an elementary Householder matrix H, of order n is a unitary matrix of the form H=I αvv^{t}, where α is a scalar. These α values are the QR auxiliary values discussed above, and v is an n-vector, with |α|²∥v∥²₂=2Re(α). Vector v is often referred to as the Householder vector. A possible way to develop a block form of an algorithm like the one discussed above is to represent a product of b elementary Householder matrices of order n as a block form of a Householder matrix. This can be done in various ways, including choosing H₁H_{2 . . .} H_{b}=IVTV^{t}, where V is an n by b matrix whose columns are the individual vectors v₁v₂ . . . v_{b} associated with the Householder matrices H₁H_{2 . . .} H_{b}, and T is an upper triangular matrix whose elements are of order b. Because the matrices only contain real entries, The QR auxiliary values α will always fall from 1 to 2 (1≦α≦2), except that α may also be 0, which is a special case in which H=I, the identity matrix.

The QR decomposition with pivoting is given by QRP^{t}, where Q and R are as specified as before but P is a permutation matrix, chosen so that |r₁₁|≧|r₂₂|≧|rₙₙ|, and moreover, for each k, |rₖₖ|≧∥R_{k:j,j}∥₂ for j=k+1 . . . n. If the column rank of the matrix X=k, then the whole of the submatrix R22 in rows and columns k+1 to n would be zero. The permutation matrix here is different from the projection matrix P discussed above. The use of P in both places is done to be consistent with notational convention.

The effective column rank, k, of the matrix X can be determined as the number of singular values which exceed a suitable threshold, in the case 1e-07.

The QR decomposition begins with the rank of both of the matrices equal to n, the number of vertices in the original graph under consideration. For each element α such that α=0, reduce the value of the rank in the respective matrix by one. Continue with the calculations of α. If any of the values of α are such that they are the same when computed from the original adjacency matrix X, it is concluded that a vertex has been repeated. Thus, there can be no Hamiltonian circuit in the original undirected graph represented by adjacency matrix X.

Generally, a first step in solving many types of matrix problems is to reduce the original matrix to a condensed form by orthogonal transformations. In the reduction to the condensed forms, the unblocked algorithms use elementary Householder matrices. Note that only in the reduction from the QR decomposition problem to Hessenberg form is it possible to use the block Householder representation described by the above QR decomposition, where the representation of using the Householder vectors and where the matrix T is filled with the α values is equivalent to the reduction of finding the QR auxiliary values in the nonsymmetrical matrix Hessenberg form applied to the block update form A=(I−VT^{t}V^{t})(A−XV^{t}).

The running time for most of these QR decomposition calculations is at most n³, where n is the number of vertices. This, by definition, is a polynomial running time. And because the QR decomposition is used to detect the presence of a Hamiltonian circuit in any undirected graph given in an adjacency matrix representation, the Hamiltonian detection algorithm runs in polynomial time. Because this NP-complete problem is in P (i.e., it can made to run in polynomial time), it is demonstrated that P=NP.

Having discussed in detail a Hamiltonian circuit detection algorithm, it is useful to discuss an exemplary application of such an algorithm. In one possible application, the determination of whether a logical expression can evaluate to TRUE is made by first converting the expression to a graph. Once a logical expression is in graphical form the above it can be represented by a matrix and the algorithm above may be used to determine a solution by detecting the presence of a Hamiltonian cycle in the graph. More formally, to detect whether or not a given logical expression, written in conjunctive normal form (k-cnf), is satisfiable or not, one approach using the algorithm of the present invention is to first map the logical construct to the Hamiltonian circuit problem discussed above and then to detect whether or not there exists a Hamiltonian circuit within the graph. If there exists a Hamiltonian circuit within the graph, then the logical expression is satisfiable, meaning that it can evaluate to TRUE. Otherwise, the logical expression is not satisfiable.

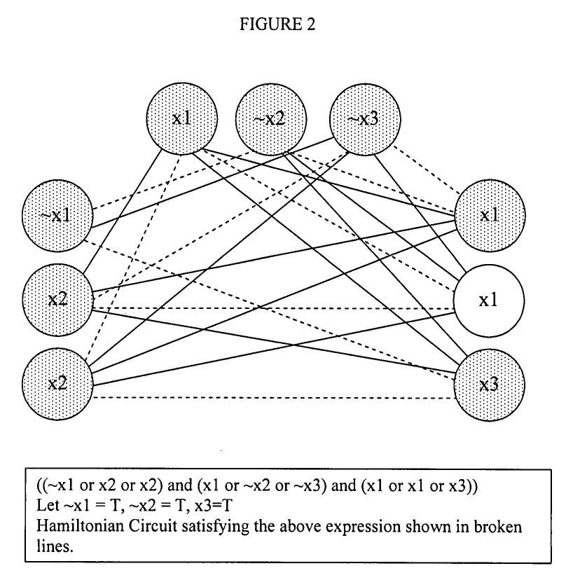

An example of this is illustrated in FIG. 2. Here, the logical expression (˜x1 or x2 or x2) and (x1 or ˜x2 or ˜x3) and (x1 or x1 or x3) is represented as a graph by separating the elements connected by ‘and’ into groups of nodes with each node representing one of the variables in that expression. To convert a logical expression written in conjunctive normal form to a graph, first create a graph whose nodes are the literals (the individual variables in the expression), grouping the literals within a single clause together. The clauses are the portions of the expressions in parenthesis separated by ‘and’ operators. Then, connect all nodes with edges, except those within a clause and those that are negations of each other. In other words, x1 and ˜x1 (“not x1”) should not be connected together, nor should the variables within the parenthetical phrases be connected together. Finally represent this graph as an adjacency matrix and input this adjacency matrix into the algorithm given below.

Next, determine whether the created undirected graph composed of vertices and edges contains a Hamiltonian circuit. If a Hamiltonian circuit is present then the k-cnf logical expression is satisfiable. If a Hamiltonian circuit is not present in the created undirected graph then the k-cnf logical expression is not satisfiable.

Since this problem is also a known NP-complete problem, the existence of a polynomial running time algorithm which solves this problem indicates that P=NP. As discussed in Computers and Intractability, an NP-complete problem can be polynomial time transformed into any known NP problem. It is also known in the art that the reverse calculation of this transformation from any NP problem into the NP-complete Hamiltonian circuit problem also has a polynomial running time. The composition of this reverse calculation from any known NP problem to the Hamiltonian circuit problem with the polynomial running time of the given algorithm together form a polynomial running time algorithm. Thus, this is a polynomial running time calculation, or P, equaling any known NP problem or NP. Hence the theorem: P=NP will have been proved upon the giving of this Hamiltonian circuit detection algorithm.

The applications of this solution are wide ranging. As noted earlier, the Hamiltonian circuit problem can be converted into any other NP problem in polynomial time. Thus, applications in networking, logistics, encryption, compression, integer and prime factorization to name a few are contemplated and within the scope of the invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for determining whether a given undirected graph composed of vertices and edges contains a Hamiltonian circuit, comprises:
loading as an input an adjacency matrix representation of an undirected graph, X=(V,E) where |V| is a number of vertices within the graph and |E| is a number of edges in the graph;
processing the adjacency matrix X to verify that it is square;
verifying that each element of the adjacency matrix X is either one or zero;
copying adjacency matrix X to A, and making each element in A equal to zero;
setting a column rank variable of each of adjacency matrices X and A to r_{X} and r_{A}, respectively, which are equal to the number of vertices n in the undirected graph |V|;
determining whether there are at least two separate one elements within a row or a column;
creating a simple connected graph having a plurality of vertices and edges such that each vertex is connected to two other vertices by two edges, respectively, and storing said graph in the adjacency matrix A;
forming a projection matrix by the operation P=(A^{t})*A, where A^{t} refers to the transpose of A;
multiplying the projection matrix P and the adjacency matrix X together, (PX=P·X); and
determining whether PX is self-consistent.

2. A computer readable medium comprising computer executable instructions adapted to perform the method of claim 1.

3. A system for determining whether a given undirected graph having a predetermined number of vertices and edges contains a Hamiltonian circuit, said system comprises:
a computer having a central processing unit and a memory unit;
an input file storing an input matrix representing the given undirected graph;
said central processing unit reading said input file and storing said input matrix in said memory unit;
said central processing unit determining whether said input matrix is square and verifying that each element of the input matrix has a value of ‘1’ or ‘0’;
said central processing unit copying the input matrix to an adjacency matrix, setting each element in the adjacency matrix to ‘0’, and storing said adjacency matrix in the memory unit;
said central processing unit setting a column rank variable for the input matrix and the adjacency matrix to the number of vertices in the undirected graph;
said central processing unit summing each of the rows and columns of the input matrix and testing whether each sum is less than two;
said central processing unit outputting to an output device a message that the undirected graph does not contain a Hamiltonian circuit if any of said sums is less than two;
said central processing unit storing a ‘1’ in each element of the adjacency matrix below the main diagonal and in each element of the adjacency matrix above the main diagonal;
said central processing unit forming a projection matrix of the adjacency matrix and storing said projection matrix in the memory unit;
said central processing unit applying the projection matrix to the input matrix to form a projected input matrix; and
said central processing unit comparing a rank of the projected input matrix to the rank of the input matrix, and if the rank of the input matrix is greater than the rank of the output matrix, said central processing unit outputting to the output device a message that the input matrix represents a Hamiltonian circuit.
